(19) United States
(12) Patent Application Publication
(10) Pub. No.: US 2014/0096628 A1
(43) Pub. Date: Apr. 10, 2014

(54) METHOD FOR DETERMINING WETTABILITY

(71) Applicant: Schlumberger Technology Corporation, Sugar Land, TX (US)

(72) Inventor: EVGENY NIKOLAEVICH DYSHLYUK, MOSCOW (RU)

(73) Assignee: SCHLUMBERGER TECHNOLOGY CORPORATION, SUGAR LAND, TX (US)

(21) Appl. No.: 14/049,686

(22) Filed: Oct. 9, 2013

(30) Foreign Application Priority Data
Oct. 10, 2012 (RU) 2012143228

(51) Int. Cl. G01N 13/02

(52) U.S. Cl. CPC G01N 13/02
USPC 73/866

(57) ABSTRACT

Surface wettability of a material is determined by placing at least one sample of this material in at least one sealed calorimeter cell. Then a contact is provided of the at least one sample with a first wetting fluid and with a second wetting fluid at the same temperature and pressure. Heats of immersion are measured of the at least one sample in the first and the second wetting fluids and a wettability parameter is calculated for a solid/fluid/fluid system.

### CROSS-REFERENCE TO RELATED APPLICATION

This application claims priority to Russian Patent Application No. RU2012143228 filed Oct. 10, 2012, which is incorporated in its entirety herein by reference.

The invention is related to surface wettability measurements and may be used in various industries, for instance, in oil and gas, chemical, paint and varnish, and food industries.

Wettability is a tendency of a fluid to spread on a solid surface and to remain in contact or to lose contact with the surface in the presence of another immiscible fluid. Wettability is an important parameter characterizing a contact of two immiscible fluids with a solid surface in oil and gas industry, pharmaceutical and light industry, and other businesses.

For instance, in oil and gas industry wettability is one of the key parameters defining location of fluids in a reservoir and distribution of flows. Being the major factor defining the location of fluids in a porous space, wettability effects all types of reservoir property measurements: electrical properties, capillary pressure, relative permeability etc. Wettability strongly affects oil production methods and efficiency, especially secondary and tertiary recovery methods.

The main method that is used for wettability estimation is the estimation of a contact angle between a solid surface and an interface between two immiscible fluids (See for instance, the U.S. Pat. No. 7,952,698).

The major drawbacks of the known method is the long time required for an equilibrium contact angle to be achieved (up to 1,000 hours), contact angle hysteresis that is caused by many reasons, such as heterogeneity of a surface, surface irregularities etc. The other drawback of the method is that the method is applied to smooth surfaces, and it is very difficult or even impossible to apply it to porous media. For instance, in the oil and gas industry in most cases porous media wettability is determined by a petro-physical analysis of core samples, rather than by contact angle estimation. The petro-physical analysis of core samples is conducted primarily by the Amott method (E. Amott, Observations Relating to the Wettability of Porous Media, Trans, AIME, 216, 156-162, 1959) or modifications thereof: the Amott-Harvey and USBM method (See for instance, J. C. Trantham, R. L. Clampitt, Determination of Oil Saturation After Waterflooding in an Oil-Wet Reservoir—The North Burbank Unit, Tract 97 Project,” JPT, 491-500 (1977)).

All these methods simulate oil recovery from a reservoir, and are based on successive displacement of oil by a mineral solution or a mineral solution by oil in a core sample by natural or induced imbibition (by centrifuging) of a core sample and subsequent measurement of fluid saturation. All the above mentioned methods are indirect and fail to provide accurate data on such thermodynamic property as wettability. Besides these methods have low sensitivity to neutral wettability or for small-size core samples.

New methods for wettability determination are based on calorimetric measurements. Wettability measurements were conducted for the solid/fluid/gas system (saturated vapor of a given fluid) (See for example, R. Denoyel, I. Beurroies, B. Lefevre, Thermodynamics of Wetting: Information Brought by Microcalorimetry, J. of Petr. Sci. and Eng., 45, 203-212, 2004).

Wettability measurements in a system of solid/fluid/saturated vapor fail to estimate wettability in a system involving two different fluids, that is, a solid/fluid/fluid system. For instance, the fact that water completely wets a given surface in the system with its saturated vapor gives no information about the wettability of the same water-wetted surface in a system with another fluid, for instance, oil.

The invention provides for increased quality and efficiency of measuring wettability of solid surfaces by two fluids at various pressure and temperature values, a shorter time needed for such operations, and lower risk of improper measurement.

The method for determining wettability of a surface comprises placing at least one sample of a material being studied in at least one sealed cell of a calorimeter and providing a contact of the at least one sample with a first wetting fluid and with a second wetting fluid at the same pressure and temperature. Heats of immersion of a surface of the at least one sample in the first and the second wetting fluids are measured and a surface wetting parameter is calculated by the following formula:

$$W = \frac{{Δ}_{imm} {u}_{1} - {Δ}_{imm} {u}_{2}}{A [ {γ}^{{L}_{1} {L}_{2}} - T \frac{\partial }{\partial T} {γ}^{{L}_{1} {L}_{2}} ]}$$

where Δᵢₘₘu₁—a heat of immersion of the surface of the sample in the first wetting fluid, Δᵢₘₘu₂—a heat of immersion of the surface of the sample in the second wetting fluid, A—a surface area of the sample, γ^{L}^{₁}^{L}^{₂}—a surface tension between the first and the second wetting fluids, T—a temperature of measurements,

$$\frac{\partial }{\partial T} {γ}^{{L}_{1} {L}_{2}}$$

—change of the surface tension between the first and the second wetting fluids with the temperature.

Preliminary a contact between the first and the second wetting fluids is provided at temperature and pressure of subsequent measurements of heat of immersion.

The surface area of the sample required for calculating the wetting parameter may be determined by method of gas adsorption or by a calorimeter using the Harkins-Jura method.

The surface tension between the wetting fluids and change of the surface tension with temperature may be determined by the method of rotating drop or by the method of a sitting drop.

In accordance with one embodiment of the invention a contact between the sample and the first wetting fluid is provided and the heat of immersion of the sample surface in the first fluid is measured. Then the sample surface is purified and a contact between the sample and the second wetting fluid is provided in the same cell of the calorimeter. The heat of immersion of the sample surface in the second fluid is measured.

According another embodiment of the invention two identical samples having the same surface areas are used. Each sample is placed in a separate cell and a contact is provided in a first cell between a first sample and the first wetting fluid. In a second cell a contact between a second sample and the second wetting fluid is also provided. A heat of immersion of the first sample in the first fluid and a heat of immersion of the second sample in the second fluid are measured.

Preliminary the sample may be dried, purified and vacuum-processed.

It is preferable to keep the cell with the sample at temperature at which the heat of immersion is measured until stabilization of heat flow.

A rock core can be used as the sample.

Any immiscible fluid can be used as the wetting fluids, for example, oil and water or salt brine, including at formation pressure and temperature.

According to the proposed method a sample of a material being studied is placed into a cell of a Differential Scanning calorimeter (DSC). DSC is capable of operating at various temperatures (the temperature range depends on the calorimeter model), and some DSCs may have cells for measurements under high pressure or in vacuum. For measurements described in this invention, DSC should be combined with a system allowing controlled variation of pressure inside the cells. Such a system would control pressure in the cells during experiments, which improves the quality of wettability measurements, including under high pressure. Pumps of various types combined with pressure gauges and connected with the cells by pipes can be used for such purposes.

A macroscopic contact angle between phase interface Fluid 1/Fluid 2 (denoted as L1 and L2) and a solid surface (S), measured from a contact between the surface and one of the fluids (for instance, L2) (normally, a fluid with a higher density is chosen) is a convenient characteristic of surface wettability. The Young equation relates a value of surplus surface heat (surface tension) at a phase interface to a value of a contact angle:

$$cos Θ = \frac{{γ}^{SL 1} - {γ}^{SL 2}}{{γ}^{{L}_{1} {L}_{2}}} \qquad ( 1 )$$

if γ^{SL}^{₁}−γ^{SL}^{₂}>γ^{L}^{₁}^{L}^{₂}, no contact angle is formed, the fluid L2 will spread on the surface without forming a contact angle and will displace the fluid L1; similarly, if γ^{SL}^{₂}−γ^{SL}^{₁}<γ^{L}^{₁}^{L}^{₂}, the fluid L1 will displace the fluid L2 from the surface. So in order to categorize the surface/fluid/fluid systems it would be most convenient to use a wettability parameter W, the value of which could range from less than −1 to more than 1:

$$W = \frac{{γ}^{SL 1} - {γ}^{SL 2}}{{γ}^{{L}_{1} {L}_{2}}} \qquad ( 2 )$$

With the formation of a final contact angle W=cos θ, at W>1, the fluid L2 will displace the fluid L1 from the surface, and at W<−1, fluid L1 will displace the fluid L2 from the surface. Therefore, the parameter W contains all necessary information on wettability.

An heat of immersion is a heat generated (or absorbed) when a surface that was in contact with a some medium M (gas, vacuum) is immersed in a fluid L so that the entire surface S which was in contact with the medium is covered with a macroscopic fluid layer. The heat of immersion depends on an initial condition of the surface. Also, the presence of a gas in the sample prior to immersion may prevent complete wetting of the sample surface. Therefore, for determining the heat of immersion the sample should preferably be immersed from vacuum, and normally, long-time vacuum pre-treatment is required at high temperatures. The time and temperature depends on the sample. For such measurements, vacuum pre-treatment is frequently conducted for 24 hours at temperatures about 100° C. DSCs allow measurement of a heat of immersion at various pressures and temperatures. The heat of immersion measured at constant pressure in the system is related to a change of the surface tension on solid surface boundary as follows:

$${Δ}_{imm} u = A [ ( {γ}^{SL} - {γ}^{SM} ) - T \frac{\partial }{\partial T} ( {γ}^{SL} - {γ}^{SM} ) ] , \qquad ( 3 )$$

where Δᵢₘₘu—the heat of immersion, A—a surface area of the wetted sample, γ^{SL}—a surface tension on the solid/fluid boundary (after wetting), γ^{SM}—a surface tension on the solid/gas boundary (vacuum) before the immersion, T—temperature of measurement.

By measuring heats of immersion of the same sample with the same initial conditions using two different fluids (1 and 2) the following can be obtained:

$${Δ}_{imm} {u}_{1} - {Δ}_{imm} {u}_{2} = A [ ( {γ}^{{SL}_{1}} - {γ}^{{SL}_{2}} ) - T \frac{\partial }{\partial T} ( {γ}^{{SL}_{1}} - {γ}^{{SL}_{2}} ) ] \qquad ( 4 )$$

Assuming that the change of the contact angle in response to temperature variation is small, one can show that:

$$W = \frac{{γ}^{{SL}_{1}} - {γ}^{{SL}_{2}}}{{γ}^{{L}_{1} {L}_{2}}} = \frac{( {γ}^{{SL}_{1}} - {γ}^{{SL}_{2}} ) - T \frac{\partial }{\partial T} ( {γ}^{{SL}_{1}} - {γ}^{{SL}_{2}} )}{{γ}^{{L}_{1} {L}_{2}} - T \frac{\partial }{\partial T} ( {γ}^{{L}_{1} {L}_{2}} )} \qquad ( 5 )$$

As follows from (4) and (5),

$$W = \frac{{Δ}_{imm} {u}_{1} - {Δ}_{imm} {u}_{2}}{A [ {γ}^{{L}_{1} {L}_{2}} - T \frac{\partial }{\partial T} {γ}^{{L}_{1} {L}_{2}} ]} . \qquad ( 6 )$$

So in order to determine the wettability parameters two experiments are needed for estimating heats of immersion from the same controlled initial surface condition (for instance, vacuum), at first measuring a heat of immersion in one wetting fluid and then (after the treatment of the sample) in the other wetting fluid. The DSC allow to conduct these two experiments concurrently studying the differential effect, i.e., two identical samples or two portions of the same sample could be wetted concurrently by one fluid in a cell with a sample and by another fluid in a reference cell (the sample should be sufficiently homogenous, and the two portions of the sample should have similar surface areas). The sample surface area A may be measured either by another known method (for instance, the BET gas adsorption method, BET Adsorption of Gases in Multimolecular Layers. Brunauer, S., Emmett, P. and Teller, E. 1938, J. Am. Chem. Soc., Vol. 60, p. 309), or by a modified Harkins-Jura method using the same experimental device (Partyka S., Rouquerol F., Rouquerol J., Calorimetric Determination of Surface Areas: Possibilities of a Modified Harkins and Jura Procedures, Journal of Colloid and Interface Science, Vol. 68, No. 1, January 1979).

The surface tension between the fluids γ^{L}^{₁}^{L}^{₂} and its change with temperature

$$\frac{\partial }{\partial T} {γ}^{{L}_{1} {L}_{2}}$$

under the desired pressure may be measured separately, for instance, by method of a rotating drop, a sitting drop, etc.

Various types of calorimeter measurement cells are used to measure heats of immersion. The most frequently used type is a sealed cell in which a sample is placed enclosed in a leak-proof glass bulb. The bulb with the sample is vacuum-treated and sealed in order to ensure control of the surface condition prior to the experiment startup. During the experiment, the bulb is broken down and the sample is wetted by a fluid. A membrane cell is a cell normally partitioned by a metal membrane into two parts. A lower part is used to place the sample; an upper part is for the fluid. During the experiment, the membrane is cut through and the fluid flows down into the lower part. The advantage of that type of cells is that there is no need to seal the sample in a leak-proof bulb. The disadvantage is that the sample receives no vacuum pre-treatment, which may lead to serious errors in measurement of heat of immersion. Another cell combines the benefits of both the above described cells. The sample and the fluid are separated by a membrane, and a lower part has a vacuum lock and could be vacuumed prior to the experiment startup. A drawback of all the above-described cells is that there is no pressure control during the experiment because none of them has pipe connection with other parts of the tool. In these cells it is hard, even impossible to conduct experiments under higher pressure.

The paper by R. Denoyel, I. Beurroies, and B. Lefevre, Thermodynamics of Wetting: Information Brought by Microcalorimetry, J. of Petr. Sci. and Eng., 45, 203-212, 2004 proposes to determine a heat of immersion using a calorimeter with controlled pressure in a cell. The cell is connected by pipes through a T-shaped adapter to a vacuum pump, which allows to perform vacuum treatment of the sample before the experiment startup, and is also connected to a system feeding fluid to the cell and creating fluid pressure in it. It should be noted that the temperature of the fluid fed into the cell should be close to that in the cell in order to avoid additional heat flow which make heat of immersion measurements difficult. Such a system or a similar one is preferable for measuring heat of immersion by the proposed method, because in that case the sample may undergo preliminary vacuum treatment before wetting and final pressure can be controlled in the system.

Additional heat effects should be considered in each of the above configurations during the experiment: the heat effects from the bulb break or membrane rupture, evaporation of a portion of the fluid, temperature difference between the entering fluid and the cell itself, fluid compression in the cell (when adding pressure to the desired level) (FIG. 5), etc. Such heat effects can normally be taken into account through additional measuring.

The method for determining wettability according to the invention is described below.

A surface of a sample is purified. For instance, in oil and gas industry, a rock sample would normally be extracted and vacuum-treated at high temperature in a vacuum furnace. The sample drying temperature and duration is determined based on properties of the sample. For instance, rock samples are vacuum-dried at a high temperature (−100° C.) for sufficient time to remove moisture (about twenty four hours). Accelerated drying is possible at still higher temperatures if such higher temperature causes no structural change of the sample surface.

The sample is placed in a sealed calorimeter measurement cell and vacuumed. Purifying of the sample and vacuum treatment may be combined if construction of the cell allows vacuum drying of the sample inside the cell at high temperature. The sample may not be subjected to vacuum treatment if such treatment is irrelevant to the end result of the experiment, i.e., heat of immersion.

The cell with the sample is kept at measurement temperature until stabilization of the heat flow.

Wetting fluids to be used for measuring heat of immersion are also prepared. Since equilibrium condition of wetting is being studied, the fluids to be used should also be brought into equilibrium, which is achieved by bringing them in contact at temperature and pressure of subsequent measurement of heat of immersion.

An experiment is conducted to measure a heat of immersion of the sample in a first wetting fluid. In order to measure the heat of immersion, the electrical signal readings from calorimeter sensors are converted into a heat flow, for which purpose the calorimeter would be calibrated; the heat of immersion is determined from the heat flow summed up during the experiment minus the baseline.

The sample is purified, vacuum-treated, and its previous condition (before the first wetting) is restored to the maximal possible extent, following which an experiment is conducted to determine the sample heat of immersion in a second fluid.

If two identical samples are used or if the sample under study is sufficiently homogenous and could be split into two pieces with similar properties, then heat of immersion may be measured in two fluids concurrently, for which purpose the samples are placed in different cells and wetted by two different fluids at a time.

Additional heat effects are considered unrelated to sample wetting.

A wettability parameter of the sample is calculated by formula (6) relative to said fluids. The surface tension between the wetting fluids and its change in response to temperature variation under a given pressure are considered as known. Their values may be taken from tabulated values for known fluids or they may be measured, for instance by method of a rotating or sitting drop at a given temperature and pressure. The sample surface area needed to determine wettability may be defined by a separate experiment, for instance, by method of gas adsorption or the Harkins-Jura method using a calorimeter, or by any other known method. The Harkins-Jura method shows good results only for surfaces wetted by a given fluid, for instance, water used for hydrophilic surfaces (in the solid/water/water vapor system) or hydrocarbons used for hydrophobic surfaces. However, if the aim is to determine wettability in the solid/fluid-1/fluid 2 system and at least one of those fluids can be used for defining the surface area by the Harkins-Jura method, then both the surface area and heat of immersion for that fluid could be determined within a single experiment. For that purpose, the vacuum-treated sample contacts the fluid vapor under a pressure lower than its saturation pressure at a given temperature (for water, ˜0.4 of the saturation pressure, could be different for other fluids) and the resulting heat E1 is measured, following which the sample is wetted by the fluid under study and heat E2 is measured. The E2 value is used to determine the surface area by the Harkins-Jura method, and the sum total of heat measurements (E1+E2) represent heat of immersion of the sample in the fluid in question.

1. A method for determining wettability of a surface comprising:
placing a sample of a material in a sealed cell of a calorimeter,
providing a contact of the sample with a first wetting fluid and with a second wetting fluid at the same pressure and temperature,
measuring heats of immersion of a surface of the sample in the first and the second wetting fluids, and
calculating a surface wetting parameter as
$$W = \frac{{Δ}_{imm} {u}_{1} - {Δ}_{imm} {u}_{2}}{A [ {γ}^{{L}_{1} {L}_{2}} - T \frac{\partial }{\partial T} {γ}^{{L}_{1} {L}_{2}} ]}$$
where Δᵢₘₘu₁—a heat of immersion of the surface of the sample in the first wetting fluid, Δᵢₘₘu₂—a heat of immersion of the surface of the sample in the second wetting fluid, A—a surface area of the sample, γ^{L}^{₁}^{L}^{₂}—a surface tension between the first and the second wetting fluids, T—a temperature of measurements,
$$\frac{\partial }{\partial T} {γ}^{{L}_{1} {L}_{2}}$$
—change of the surface tension between the first and the second wetting fluids with the temperature.

2. The method of claim 1, wherein preliminary a contact between the first and the second wetting fluids is provided at the temperature and pressure of subsequent measurements of the heats of immersion.

3. The method of claim 1, wherein the surface area of the sample required for calculating the wetting parameter is determined by method of gas adsorption.

4. The method of claim 1, wherein the surface area of the sample required for calculating the wetting parameter is determined by a calorimeter using the Harkins-Jura method.

5. The method of claim 1, wherein the surface tension between the wetting fluids and the change of the surface tension with temperature is determined by the method of a rotating drop.

6. The method of claim 1, wherein the surface tension between the wetting fluids and the change of the surface tension with temperature is determined by the method of a sitting drop.

7. The method of claim 1, wherein a contact between the sample and the first wetting fluid is provided and the heat of immersion of the sample surface in the first fluid is measured, then the sample surface is purified and a contact between the sample and the second wetting fluid is provided in the same cell of the calorimeter and the heat of immersion of the sample surface in the second fluid is measured.

8. The method of claim 7, wherein the sample is preliminary vacuum-processed.

9. The method of claim 7, wherein the sample is preliminary dried and purified.

10. The method of claim 7, wherein the cell with the sample is kept at temperature at which the heat of immersion is measured until stabilization of heat flow.

11. The method of claim 1, wherein two identical samples having the same surface areas are used, each sample is placed in a separate cell and in a first cell a contact is provided between a first sample and the first wetting fluid and in a second cell a contact is provided between a second sample and the second wetting fluid, and a heat of immersion of the first sample in the first fluid and a heat of immersion of the second sample in the second fluid are measured.

12. The method of claim 11, wherein the samples are preliminary vacuum-processed.

13. The method of claim 10, wherein the samples are preliminary dried and purified.

14. The method of claim 11, wherein the cells with the samples are kept at temperature at which the heat of immersion is measured until stabilization of heat flow.

15. The method of claim 1, wherein a rock core is used as the sample.

16. The method of claim 1, wherein oil and salt brine are used as the wetting fluids.

17. The method of claim 16, wherein oil and salt brine at formation temperatures and pressures are used as the wetting fluids.
